(19) United States
(12) Patent Application Publication
(10) Pub. No.: US 2008/0237913 A1
(43) Pub. Date: Oct. 2, 2008

(54) METHOD FOR STRETCHING POLYMER FILM

(75) Inventor: Shinsuke Aoshima, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/058,631

(22) Filed: Mar. 28, 2008

(30) Foreign Application Priority Data
Mar. 28, 2007 (JP) 2007-084424

(51) Int. Cl. D01D 5/40; B29C 55/04

(52) U.S. Cl. 264/140; 264/291

(57) ABSTRACT

A rear end portion of a leading TAC film and a front end portion of a following TAC film are connected using a double-sided adhesive tape and acetone, in order to stretch the TAC films continuously in a tenter. The double-sided adhesive tape is constituted of a base whose material is same as the TAC film and an adhesive layer coated on both surfaces of the base. Acetone is one of solvents used for preparing a dope in the TAC film production. The double-sided adhesive tape is firstly stuck on an upper surface of the rear end portion of the leading TAC film. Acetone is then applied, using a spray, on coating areas of the rear end portion of the leading TAC film. After that, the front end portion of the following TAC film is layered on the rear end portion of the leading TAC film, and the films are pressed and connected.

### FIELD OF THE INVENTION

The present invention relates to a method for stretching polymer films.

### BACKGROUND OF THE INVENTION

Polymer films used for optical applications are generally produced according to a solution casting method. In the solution casting method, which is a representative method for producing the polymer films, a dope is cast onto a support using a die. The dope forms a casting film on the support. The casting film is peeled and dried, and then wound up to be a product. As polymer, cellulose acylate, especially triacetyl cellulose (TAC) is used.

It is proposed that the TAC films are stretched off-line, that is, outside a solution casting line in order to improve the smoothness, mechanical strength and optical properties of the TAC films (see, for example, Japanese Patent Laid-open Publication No. 2002-311240).

As disclosed in the Japanese Patent Laid-open Publication No. 2002-311240, when the films are stretched off-line, that is, independently from the solution casting line, it is preferable to stretch the films continuously so as to perform the film stretching effectively. In order to stretch the films continuously, a rear end of a leading film, which has been supplied first, and a front end of a following film, which is newly supplied, may be connected using a connection tape.

However, since the rigidity of the TAC film is different from that of the connection tape, the TAC films and the connection tape are damaged at the time of the film stretching. When the TAC films and the connection tape are damaged due to their different rigidities, the films cannot be stretched continuously. To supply the TAC films without connecting them, the following film needs to be sent to a tenter after the rear end of the leading film has been passed the tenter. This configuration may result in high losses of the TAC films, and moreover, operating time of a stretching device decreases due to the tenter adjustment and the film supplying operation. Such problems are not limited to the TAC film production, but may arise in any polymer film production.

### SUMMARY OF THE INVENTION

It is an object of the present invention to provide a method for stretching polymer films capable of avoiding damages to the films and a connection tape.

In order to achieve the above and other objects, a method according to the present invention for stretching polymer films in width directions thereof includes connecting step, supplying step, and stretching step. In the connecting step, a rear end of leading polymer film and a front end of following polymer film are connected using a connection tape. In the supplying step, the connected polymer films are supplied continuously. In the stretching step, the supplied polymer films are stretched by being held at both side edges thereof with clips. The polymer films are conveyed by the clips during the stretching step.

It is preferable that the connection tape has a base whose material is same as the polymer film, and an adhesive layer provided on the base. It is also preferable that the connection tape has a base exhibiting almost the same deformation behavior during stretching as the polymer film when temperature of the polymer film is in a preset range, and an adhesive layer provided on the base.

It is preferable that a line on which the polymer films are connected intersects with the width direction of the polymer films.

It is preferable that the method further includes slitting step and cutter-blower step. In the slitting step, the side edges are slit from main parts of the polymer films after the stretching step. The main part is a center part in the width direction of the polymer film between the side edges. The main part is going to be an end product. In the cutter-blower step, the slit side edges are cut into small pieces by a cutter blower, and the small pieces are blown by the cutter blower.

According to the present invention, the leading and following polymer films are connected using the connection tape. The connection tape has the base whose material is same as the polymer film, and the adhesive layer provided on the base. It is also possible that the connection tape has the base exhibiting almost the same deformation behavior during stretching as the polymer film when the temperature of the polymer film is in the preset range, and the adhesive layer provided on the base. With use of such connection tape, the films and the connection tape are not damaged after the film stretching. Owing to this, the polymer films can be continuously stretched.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is a schematic view illustrating an off-line stretching device;

FIG. 2 is a schematic view illustrating a tenter;

FIG. 3 is a side elevational view illustrating a clip;

FIG. 4 is a perspective view illustrating a leading TAC film, a following TAC film, a double-sided adhesive tape, and coating areas SA;

FIG. 5 is a side elevational view illustrating the leading TAC film, the following TAC film, and the double-sided adhesive tape;

FIG. 6 is a side elevational view illustrating the leading TAC film, the following TAC film, the double-sided adhesive tape, and a single-sided adhesive tape;

FIG. 7 is a side elevational view illustrating the leading TAC film, the following TAC film, and the single-sided adhesive tapes;

FIG. 8 is another side elevational view illustrating the leading TAC film, the following TAC film, and the single-sided adhesive tapes;

FIG. 9 is a side elevational view illustrating a heat sealer;

FIG. 10 is a side elevational view illustrating an ultrasonic joining device; and

FIGS. 11A and 11B are top plan views respectively illustrating the leading TAC film, the following TAC film, the double-sided adhesive tape, and the single-sided adhesive tapes, wherein a line on which the leading and following TAC films are connected intersects with the width direction of the TAC films.

### DESCRIPTION OF THE PREFERRED EMBODIMENTS

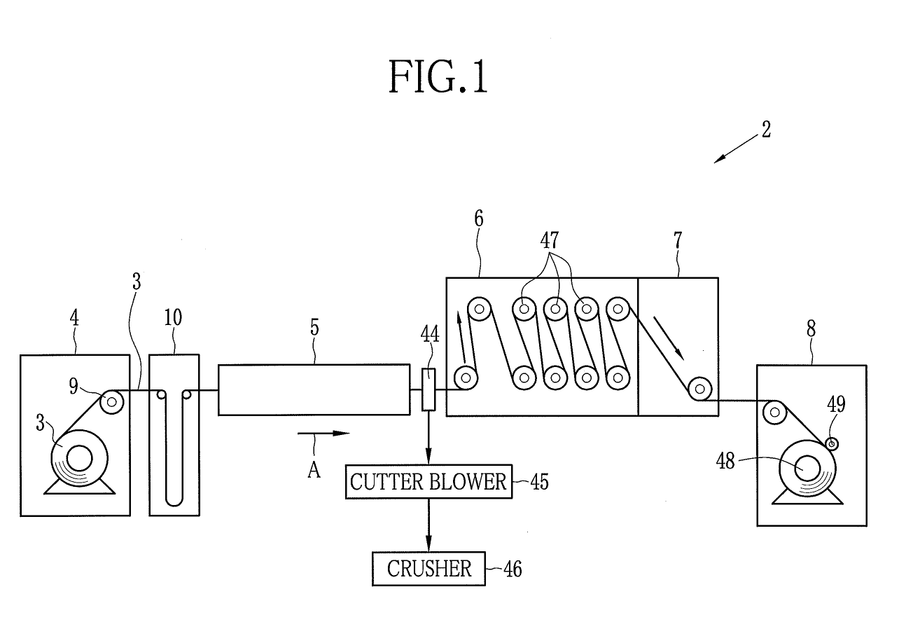

As shown in FIG. 1, an off-line stretching device 2 is for stretching a TAC film 3, and provided with a supplying chamber 4, a tenter 5, a stress relaxation chamber 6 by heating, a cooling chamber 7, and a winding chamber 8. The supplying chamber 4 stores the TAC film 3 in a roll form. The TAC film 3 is supplied by a supply roller 9 to the tenter 5.

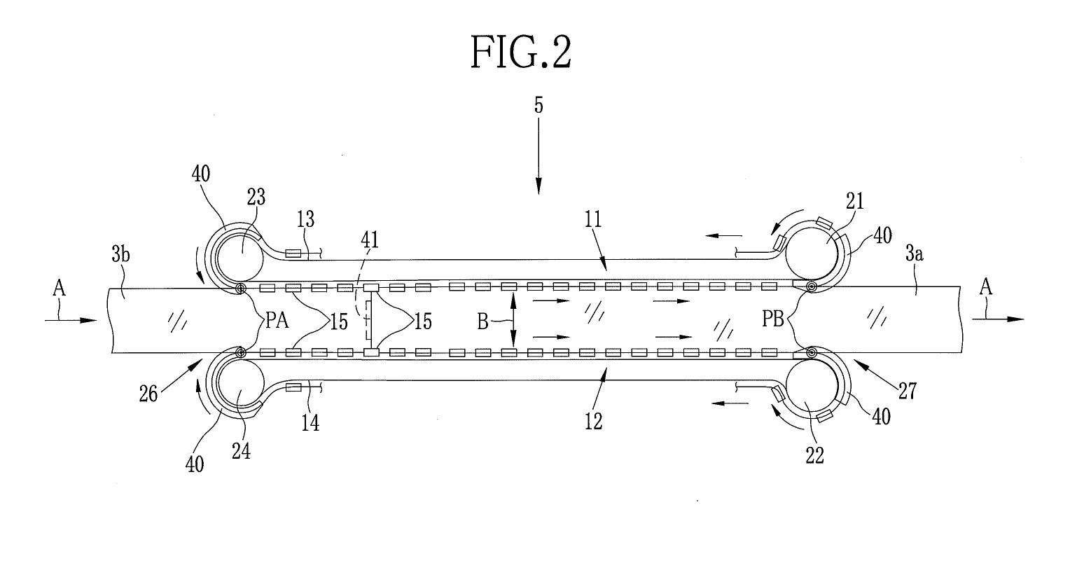

In the tenter 5, both side edges of the TAC film 3 are held with clips 15 (see FIG. 2). While being conveyed at this state, the TAC film 3 is heated and stretched in film width directions B (see FIG. 2). The TAC film 3 is stretched by preferably 100.5% to 300% in the film width directions B with respect to the width of the TAC film 3 before the stretching.

A reservoir 10 is provided between the supplying chamber 4 and the tenter 5. In the reservoir 10, a certain length of TAC film 3 is reserved to form a loop. The certain length is a length enough for connecting the TAC films 3. The film connection is described later. After forming the loop, the TAC film 3 is sent to the tenter 5.

As shown in FIG. 2, the TAC film 3 is conveyed in a convey direction A and stretched in the film width directions B in the tenter 5. The tenter 5 is provided with a first rail 11, a second rail 12, a first chain 13 and a second chain 14 (both are endless chains). The first chain 13 is guided by the first rail 11, and the second chain 14 is guided by the second rail 12. Temperature inside the tenter 5 is kept high. The tenter 5 may be divided into plural zones in the convey direction A as necessary so as to change conditions for heating the TAC film 3 in each zone. For example, the tenter 5 may be divided, from upstream to downstream thereof, into pre-heating zone, heating zone, and stress relaxation zone by heating, in the convey direction A.

The clips 15 are attached to the first and second chains 13 and 14 at certain intervals. While holding the side edges of the TAC film 3, the clips 15 are moved along each rail 11 or 12, and thereby stretching the TAC film 3 in the film width directions B. In this embodiment, the TAC film 3 is stretched in the film width directions B such that the width of the TAC film 3 after the stretching becomes 103% of the width of the same before the stretching. The stretch ratio is not limited to this, but may be appropriately changed in accordance with desired optical properties and the like.

The first chain 13 is bridged across a drive sprocket wheel 21 and a driven sprocket wheel 23, and guided by the first rail 11. The second chain 14 is bridged across a drive sprocket wheel 22 and a driven sprocket wheel 24, and guided by the second rail 12. The drive sprocket wheels 21 and 22 are provided at a tenter exit 27 side, and are driven and rotated by drive mechanisms (not shown). The driven sprocket wheels 23 and 24 are provided at a tenter entrance 26 side.

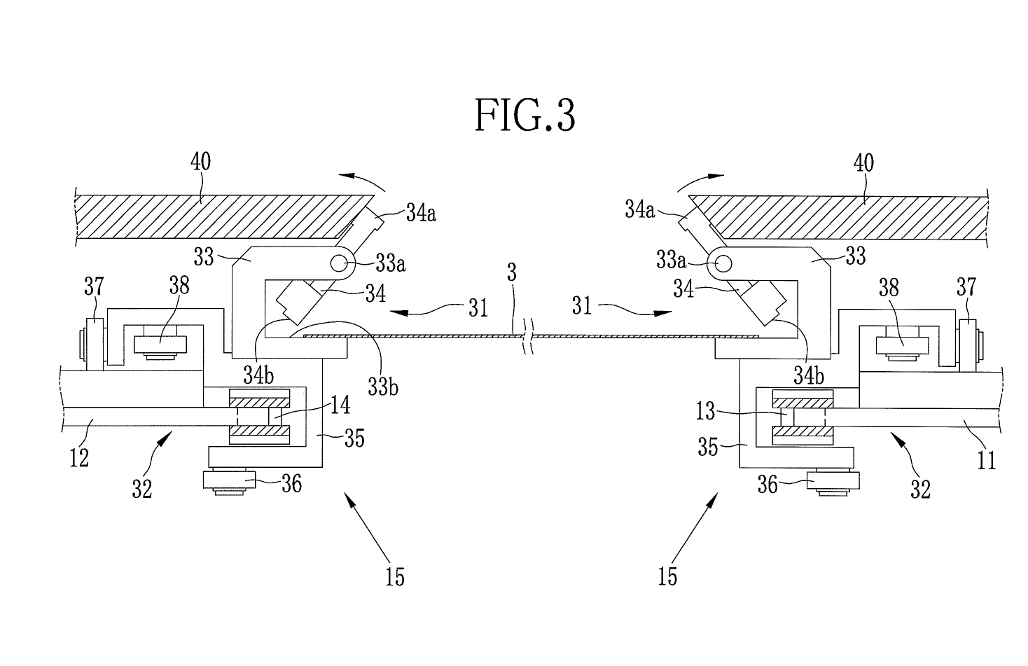

As shown in FIG. 3, each clip 15 is constituted of a clip body 31 and a rail attachment portion 32. The clip body 31 is constituted of a substantially C-shaped frame 33 and a flapper 34. The flapper 34 is rotatably attached to the frame 33 through an attachment shaft 33a. The flapper 34 moves between holding position and releasing position. In the holding position, the flapper 34 becomes vertical. In the releasing position, as shown in FIG. 3, a releasing member 40 contacts and pushes an engagement head 34a of the flapper 34, and thereby tilting the flapper 34 from the vertical position. That is, the flapper 34 swings around the attachment shaft 33a. The flapper 34 is normally in the holding position under its own weight. The TAC film 3 is held between a film holding surface 33b of the frame 33 and a flapper lower surface 34b of the flapper 34 at a position (holding initiation point) PA (see FIG. 2).

The rail attachment portion 32 is constituted of an attachment frame 35 and guide rollers 36, 37 and 38. The first chain 13 or the second chain 14 is attached to the attachment frame 35. The guide rollers 36, 37 and 38 rotate by contacting with a support surface of the drive sprocket wheel 21 or 22, or a support surface of the first rail 11 or the second rail 12. Owing to this, the clip 15 is guided along the first rail 11 or the second rail 12 without dropping off of the drive sprocket wheel 21 or 22.

The releasing member 40 is arranged near the sprocket wheel 21, 22, 23 and 24 (see FIG. 2). The releasing members 40 near the driven sprocket wheels 23 and 24 contact and push the engagement heads 34a of the flappers 34 of the clips 15 at the position upstream from the position PA, and thereby putting the flappers 34 into the releasing position. Owing to this, the clips 15 can receive the side edges of the TAC film 3. At the time when the clips 15 pass the position PA, the releasing members 40 retract from the engagement heads 34a, and thereby putting the flappers 34 into the holding position. Owing to this, the clips 15 hold the side edges of the TAC film 3. In the same manner, the releasing members 40 near the drive sprocket wheels 21 and 22 put the flappers 34 into the releasing position at the time when the clips 15 pass a position (holding release point) PB. Owing to this, the clips 15 release the holding of the side edges of the TAC film 3.

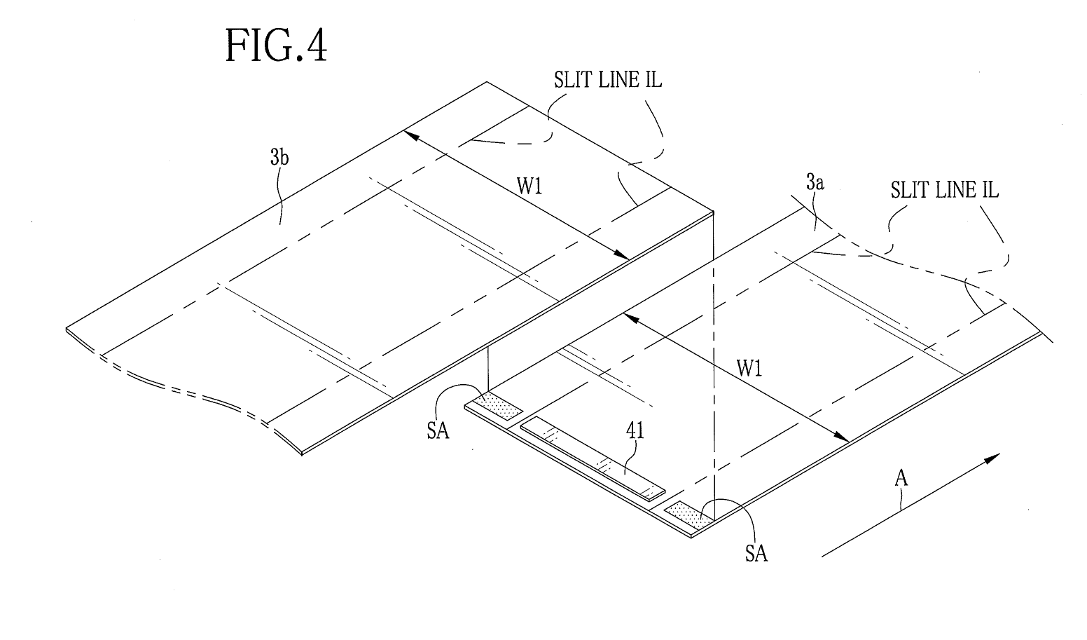

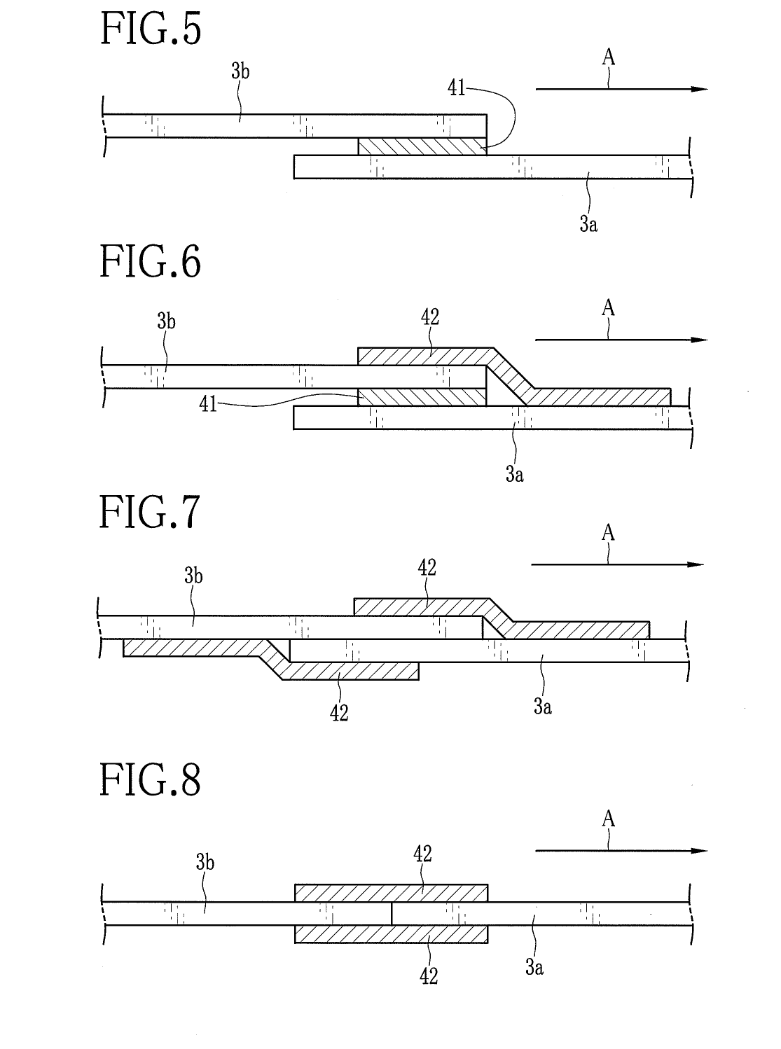

As shown in FIGS. 4 and 5, the TAC films 3 are connected to continuously stretch them in the tenter 5. A rear end portion of the TAC film 3 (leading film 3a), which has been supplied from the supplying chamber 4, and a front end portion of the newly supplied TAC film 3 (following film 3b) are connected using a double-sided adhesive tape 41. Double-coated adhesive tape No. 532 manufactured by Nitto Denko Corporation is used as the tape 41 in this embodiment. This double-sided adhesive tape 41 has a polyester base and an adhesive layer coated on both surfaces of the base. The base exhibits almost the same deformation behavior during stretching as the TAC film 3 when temperature of the TAC film 3 is in a preset range. In the present invention, the present temperature range of the TAC film 3 is 150° C. to 250° C.

When the rear end portion of the leading film 3a and the front end portion of the following film 3b are connected using the double-sided adhesive tape 41 and acetone, the double-sided adhesive tape 41 is firstly stuck on an upper surface of the rear end portion of the leading film 3a. Acetone is then applied, using a spray, on coating areas SA of the rear end portion of the leading film 3a. The coating area SA is provided at both side edges of the rear end portion of the leading film 3a. Acetone is one of solvents used for preparing the dope in the TAC film production. After that, the front end portion of the following film 3b is layered on the rear end portion of the leading film 3a, and thereby connecting the films 3a and 3b with the double-sided adhesive tape 41. At the same time, the side edges of the layered portions of the films 3a and 3b are pressed, and thereby connecting the films 3a and 3b with acetone. This film connection is performed upstream from the reservoir 10. At the time of the connection, the TAC film 3 that has been reserved in the reservoir 10 is sent to the tenter 5. Owing to this, the film connection can be performed without stopping the film conveyance. The film connection may be performed automatically by machine, or may be performed manually in the case where the off-line stretching device 2 has a simple configuration. In this embodiment, the double-sided adhesive tape 41 is used for connecting main parts of the TAC films 3. The main part of the TAC film 3 is a center part in the width direction of the TAC film 3 between the side edges. This main part is going to be a final product. Acetone is used for connecting the side edges of the TAC films 3. For this configuration, the double-sided adhesive tape 41 and acetone are not positioned on slit lines IL along which the side edges are slit.

The TAC films 3 connected using the double-sided adhesive tape 41 and acetone were stretched in the film width directions B to a stretching ratio of 1.45 times at a film temperature of 200° C. The deformation behavior during stretching of the TAC films 3 and the deformation behavior during stretching of the tape 41 were almost the same within the preset temperature range of the TAC film 3. After the stretching, the TAC films 3 and the double-sided adhesive tape 41 were not damaged, specifically, not torn nor ruptured, and their conditions were good. Accordingly, the TAC films 3 could be continuously stretched. In this embodiment, a width W1 of the TAC film 3 before the stretching was 690 mm, and a length of the films 3a and 3b overlapping with each other in the film convey direction A was 100 mm. Note that the stretching ratio of the TAC film 3 is calculated from the following formula: X1/W1. X1 is the width of the TAC film 3 after the stretching. When methyl acetate or dioxolane was used instead of acetone, the TAC films 3 and the double-sided adhesive tape 41 were also not damaged after the stretching in the film width directions B to a stretching ratio of 1.45 times at a film temperature of 200° C.

Next, Double Face R390S manufactured by Toyo Ink MFG Co., Ltd. is used as the tape 41 in this embodiment. This double-sided adhesive tape 41 has no base. The TAC films 3 connected in the same manner as described above using this tape 41 were stretched in the film width directions B to a stretching ratio of 1.45 times at a film temperature of 200° C. After the stretching, the TAC films 3 and the double-sided adhesive tape 41 were not damaged and their conditions were good. Accordingly, the TAC films 3 could be continuously stretched.

Next, a single-sided adhesive tape 42 is used in addition to the double-sided adhesive tape 41, as shown in FIG. 6. Polyester adhesive tape No. 31B manufactured by Nitto Denko Corporation is used as the tape 42 in this embodiment. This single-sided adhesive tape 42 has a polyester base and an adhesive layer coated on one surface of the base. The material of the base is same as the TAC film 3. In this embodiment, top surfaces of the films 3a and 3b are connected with the single-sided adhesive tape 42. The TAC films 3 connected using the double-sided adhesive tape 41 and the single-sided adhesive tape 42 were stretched in the film width directions B to a stretching ratio of 1.25 times at a film temperature of 150° C. and to a stretching ratio of 1.45 times at a film temperature of 200° C. After the stretching under each condition, the TAC films 3, the double-sided adhesive tape 41 and the single-sided adhesive tape 42 were not damaged and their conditions were good. Accordingly, the TAC films 3 could be continuously stretched.

Next, the single-sided adhesive tape 42 is used instead of the double-sided adhesive tape 41, as shown in FIG. 7. In this embodiment, the front end portion of the following film 3b is layered on the rear end portion of the leading film 3a, and both top and bottom surfaces of the films 3a and 3b are connected with the single-sided adhesive tapes 42. The TAC films 3 connected in this manner were stretched in the film width directions B to a stretching ratio of 1.25 times at a film temperature of 150° C. and to a stretching ratio of 1.45 times at a film temperature of 200° C. After the stretching under each condition, the TAC films 3 and the single-sided adhesive tapes 42 were not damaged and their conditions were good. Accordingly, the TAC films 3 could be continuously stretched.

Next, the single-sided adhesive tape 42 is used to connect the TAC films 3, as shown in FIG. 8. In this embodiment, the leading film 3a and the following film 3b are not layered, but a rear end edge of the leading film 3a and a front end edge of the following film 3b were confronted, and both top and bottom surfaces of the films 3a and 3b are connected with the single-sided adhesive tapes 42. The TAC films 3 connected in this manner were stretched in the film width directions B to a stretching ratio of 1.25 times at a film temperature of 150° C. and to a stretching ratio of 1.45 times at a film temperature of 200° C. After the stretching under each condition, the TAC films 3 and the single-sided adhesive tapes 42 were not damaged and their conditions were good. Accordingly, the TAC films 3 could be continuously stretched.

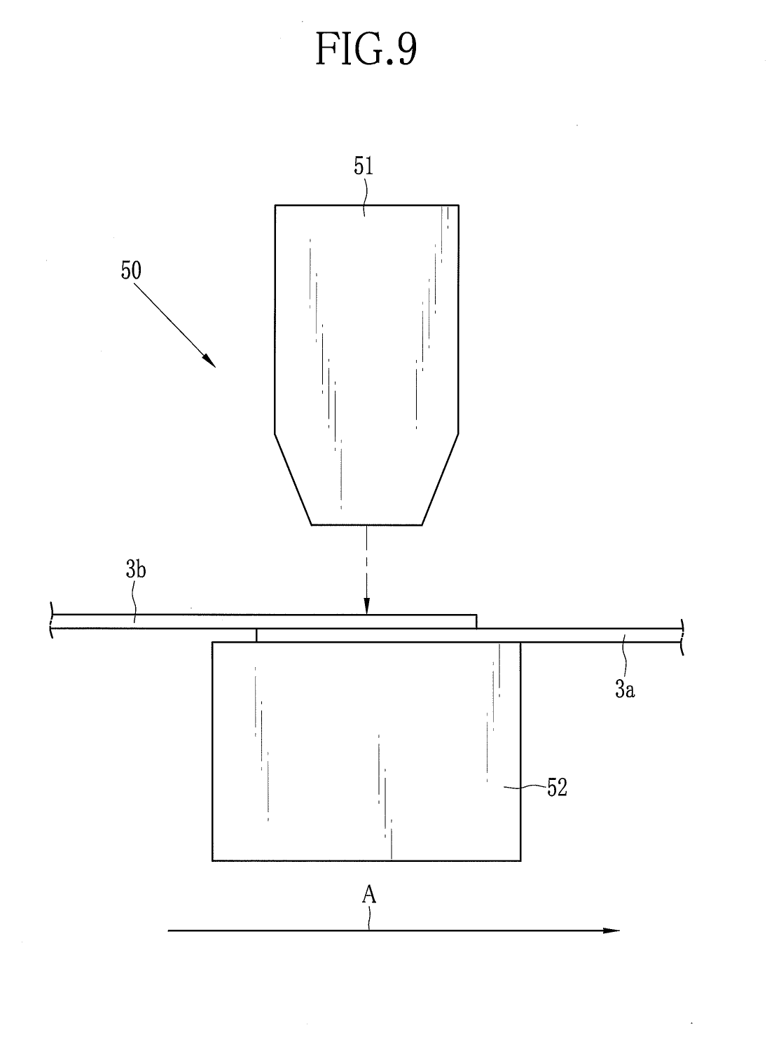

Next, the TAC films 3 are connected using a heat sealer 50, as shown in FIG. 9. The connected TAC films 3 were stretched in the film width directions B to a stretching ratio of 3 times at a film temperature of 250° C. After the stretching, the TAC films 3 were not damaged and their conditions were good. Accordingly, the TAC films 3 could be continuously stretched.

The heat sealer 50 is provided with a seal head 51. The rear end portion of the leading film 3a is placed on a stage 52, and the front end portion of the following film 3b is layered thereon. Then, the heated seal head 51 is pressed against the films 3a and 3b. The leading and following films 3a and 3b are connected by the effect of the heat conduction. Instead of the heat sealer 50, an impulse sealer may also be used for connecting the leading and following films 3a and 3b. The TAC films 3 connected using the impulse sealer were also stretched in the film width directions B to a stretching ratio of 3 times at a film temperature of 250° C. After the stretching, the TAC films 3 were not damaged and their conditions were good. Accordingly, the TAC films 3 could be continuously stretched.

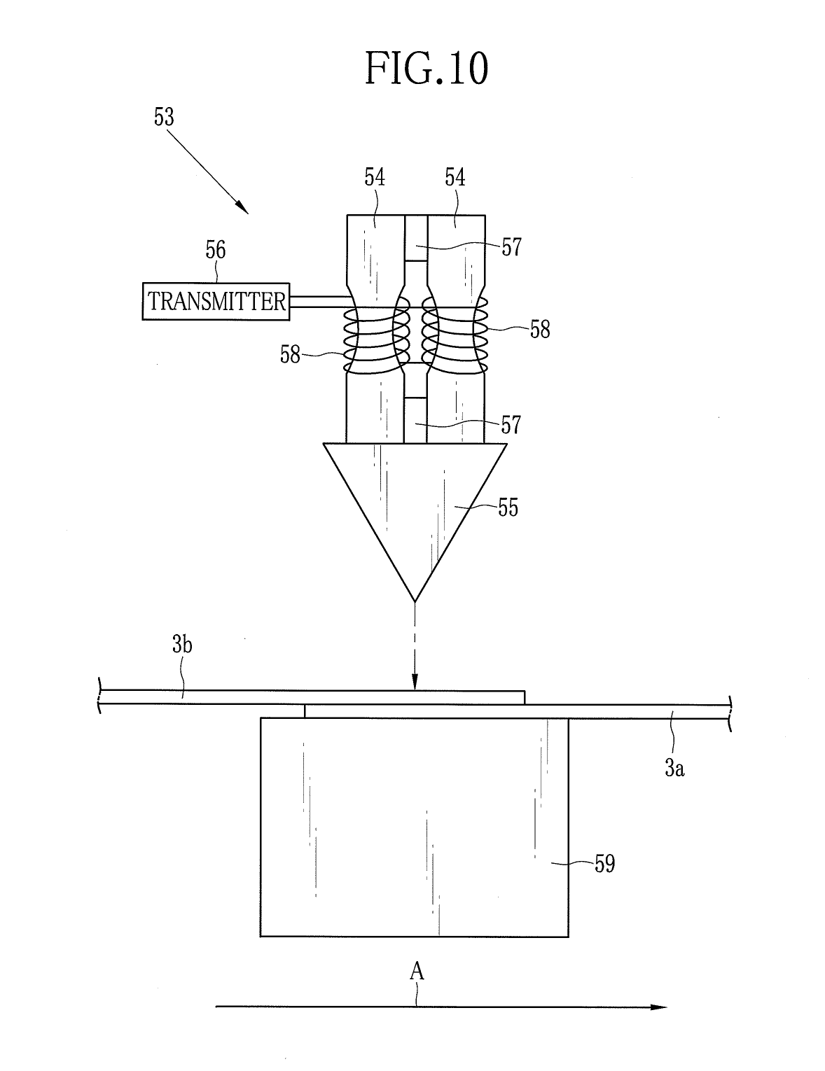

Next, the TAC films 3 were connected using an ultrasonic joining device 53, as shown in FIG. 10. The connected TAC films 3 were stretched in the film width directions B to a stretching ratio of 3 times at a film temperature of 250° C. After the stretching, the TAC films 3 were not damaged and their conditions were good. Accordingly, the TAC films 3 could be continuously stretched.

The ultrasonic joining device 53 mechanically oscillates the TAC films 3 for 20000 to 28000 times per second with amplitude of 0.03 mm. By being oscillated, the TAC films 3 are heated and welded. The ultrasonic joining device 53 is provided with transducers 54, a horn 55, and a transmitter 56. A permanent magnet 57 is provided between the transducers 54. Each transducer 54 is wounded with a coil 58. The transmitter 56 drives the transducers 54 through the coils 58. The transducers 54 convert electric oscillation into mechanical oscillation. The horn 55 amplifies the mechanical oscillation of the transducers 54 and transfers the oscillation to the leading and following films 3a and 3b on a stage 59. Owing to the oscillation, the leading and following films 3a and 3b are heated and welded.

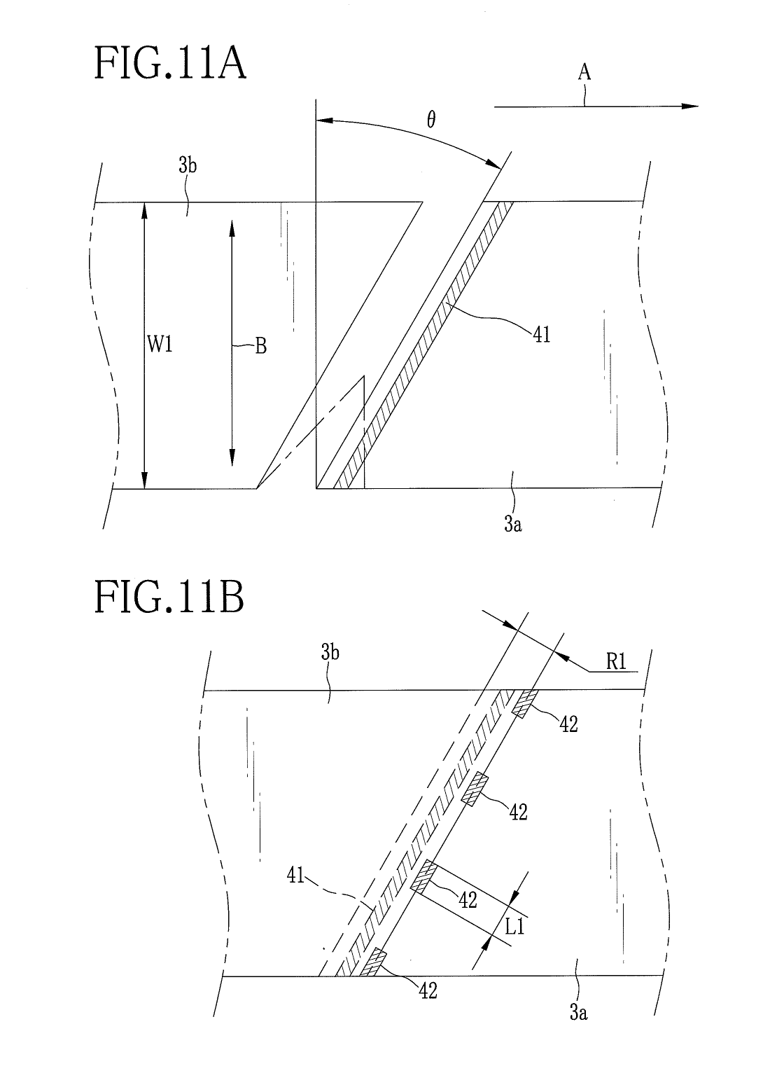

When the TAC films 3 are connected using the double-sided adhesive tape 41 and the single-sided adhesive tape 42, a line on which the TAC films 3 are connected may intersects with the film width directions B at an angle θ of, for example, 30 degrees, as shown in FIGS. 11A and 11B. First, the rear end edge of the leading film 3a and the front end edge of the following film 3b are cut such that both end edges intersect with the film width directions B of the TAC films 3, as shown in FIG. 11A. The double-sided adhesive tape 41 is stuck on the upper surface of the rear end portion of the leading film 3a.

Then, the front end portion of the following film 3b is layered on the rear end portion of the leading film 3a, and the single-sided adhesive tapes 42 are stuck on the top surfaces of the films 3a and 3b along the film connection line, as shown in 11B. The connected TAC films 3 were stretched in the film width directions B to a stretching ratio of 1.25 times at a film temperature of 150° C. and to a stretching ratio of 1.45 times at a film temperature of 200° C. After the stretching, the TAC films 3, the double-sided adhesive tape 41 and the single-sided adhesive tapes 42 were not damaged and their conditions were good. Accordingly, the TAC films 3 could be continuously stretched. In this embodiment, the width W1 of the TAC film 3 before the stretching was 690 mm, a length R1 of the films 3a and 3b overlapping with each other was 100 mm, and a length L1 of each single-sided adhesive tape 42 was 80 mm. In the case where the TAC films 3 are connected using only the double-sided adhesive tape 41, the TAC films 3 and the double-sided adhesive tape 41 were not damaged and their conditions were good after stretching the TAC films 3 in the film width directions B to a stretching ratio of 1.25 times at a film temperature of 150° C. and to a stretching ratio of 1.45 times at a film temperature of 200° C.

The angle θ is not limited to 30 degrees, but may be changed as appropriate. It is also possible to connect the TAC films 3 without cutting the rear end edge of the leading film 3a. That is, the rear end edge of the leading film 3a can be parallel to the film width directions B. In this case, the double-sided adhesive tape 41 is stuck on the upper surface of the rear end portion of the leading film 3a such that the tape 41 intersects with the film width directions B of the TAC films 3.

After the stretching in the tenter 5, the TAC films 3 are sent to an edge slitting device 44, as shown in FIG. 1. The edge slitting device 44 slits both side edges of the TAC films 3 along the slit lines IL (see FIG. 4). The slit side edges are cut into small pieces by a cutter blower 45. The small pieces are sent to a crusher 46 by a blower (not shown) and then shredded into chips by the crusher 46. When acetone, for example, is used for connecting the side edges of the films, the chips can be recycled for preparing the dope. Therefore, the materials are efficiently utilized and the production cost is reduced.

When using acetone, the side edges are dissolved in acetone and connected. In this case, the side edges can be recycled as they are being connected. Owing to this, the trouble of removing the adhesive tape is prevented. This improves the workability in recovering the slit side edges. The TAC films 3 whose side edges have been slit by the edge slitting device 44 are sent to the stress relaxation chamber 6.

In the stress relaxation chamber 6, plural rollers 47 are provided. While being conveyed by the rollers 47, the TAC films 3 are heated and thereby relaxing the internal stress thereof. In the stress relaxation chamber 6, an air blower (not shown) sends air at a desired temperature. The temperature of the air is preferably in the range of 20° C. to 250° C. Then, the TAC films 3 are sent to the cooling chamber 7.

In the cooling chamber 7, the TAC films 3 are cooled until the temperature thereof reaches 30° C. or less, and then sent to the winding chamber 8. In the winding chamber 8, the TAC films 3 are wound by a winding roll 48. At the time of winding, a press roller 49 applies tension to the TAC films 3.

The TAC film 3 is produced according to the well-known solution casting method such as, for example, a method disclosed in Japanese Patent Laid-open Publication No. 2005-104148. To increase the film production speed, the dope including TAC and the solvent is cast on the cooled drum. The casting film is cooled and gelated to have the self-supporting properties. After having possessed the self-supporting properties, the casting film is peeled. The peeled film is dried in a pin tenter and then wound into a roll form as a TAC film. When the present invention is applied to such TAC film, the TAC film having excellent optical properties can be produced effectively and efficiently.

In this embodiment, the TAC film 3 is used as the example of the polymer film. However, the present invention can also be applied to other kinds of polymer films.

Various changes and modifications are possible in the present invention and may be understood to be within the present invention.

What is claimed is:

1. A method for stretching polymer films in width directions thereof comprising the steps of:
connecting a rear end of leading said polymer film and a front end of following said polymer film using a connection tape;
supplying the connected polymer films continuously; and
stretching the supplied polymer films by holding both side edges thereof with clips, said polymer films being conveyed by said clips during said stretching step.

2. The method according to claim 1, wherein said connection tape has a base whose material is same as said polymer film, and an adhesive layer provided on said base.

3. The method according to claim 1, wherein said connection tape has a base exhibiting almost the same deformation behavior during stretching as said polymer film when temperature of said polymer film is in a preset range, and an adhesive layer provided on said base.

4. The method according to claim 1, wherein a line on which said polymer films are connected intersects with the width direction of said polymer films.

5. The method according to claim 1 further comprising the steps of:
slitting said side edges from main parts of said polymer films after the stretching step, said main part being a center part in the width direction of said polymer film between said side edges, said main part becoming an end product; and
cutting the slit side edges into small pieces by a cutter blower and blowing said small pieces by said cutter blower.
